(19) United States
(12) Patent Application Publication
(10) Pub. No.: US 2011/0161236 A1
(43) Pub. Date: Jun. 30, 2011

(54) SYSTEM AND METHOD FOR NEGOTIATING A SALE

(76) Inventors: Sharad Singhal, Belmont, CA (US); Yinping Yang, Singapore (SG)

(21) Appl. No.: 12/648,405

(22) Filed: Dec. 29, 2009

(51) Int. Cl. G06Q 30/00

(52) U.S. Cl. 705/80

(57) ABSTRACT

There is provided a computer system for negotiating a sale. A computer system comprises a processor adapted to execute stored instructions and a memory device that stores instructions for execution by the processor. The memory device comprises computer-implemented code adapted to make an offer to sell in a round of a negotiation. The memory device also comprises computer-implemented code adapted to receive a counter-offer. The memory device additionally comprises computer-implemented code adapted to determine whether to accept the counter-offer based on a pre-determined target, a best alternative to a negotiated agreement (BATNA), and the round of the negotiation.

### BACKGROUND

Many products and services are currently offered to customers over electronic networks, such as the Internet. Current models for sales are limited. For example, one model for sales can be described as “take it or leave it.” In other words, the seller specifies a price, and potential buyers can buy the item/service at the price, or not. The take it or leave it model may cost the seller potential sales when the customer is able to obtain a better deal. As such, the take it or leave it model is generally cost-effective only for low-value items/services involving single units of PCs, for example.

Another sales model may involve a human sales force. In such a model, a sales agent may interact with potential customers to customize the sale according to the customer's needs. This model is resource intensive, and typically may only be cost-effective for high-value sales, such as sales of hundreds of PCs.

For sales in the range between the high-value and low-value, such as a sale of 30-50 PCs, the take it or leave it model may forgo potential sales. However, involving a human agent to negotiate such a sale may not be cost-effective, given the balance of resources used against the profit of such a sale.

### BRIEF DESCRIPTION OF THE DRAWINGS

Certain exemplary embodiments are described in the following detailed description and in reference to the drawings, in which:

FIG. 1 is a block diagram of a system adapted for negotiation according to an exemplary embodiment of the present invention;

FIG. 2 is a process flow diagram of a computer-implemented method for negotiation according to an exemplary embodiment of the present invention;

FIG. 3 is a process flow diagram of a computer-implemented method for making multiple equivalent offers according to an exemplary embodiment of the present invention;

FIG. 4 is a process flow diagram of a computer-implemented method for determining whether to accept an offer according to an exemplary embodiment of the present invention; and

FIG. 5 is a block diagram showing a tangible, machine-readable medium that stores code adapted for negotiating a sale according to an exemplary embodiment of the present invention.

### DETAILED DESCRIPTION

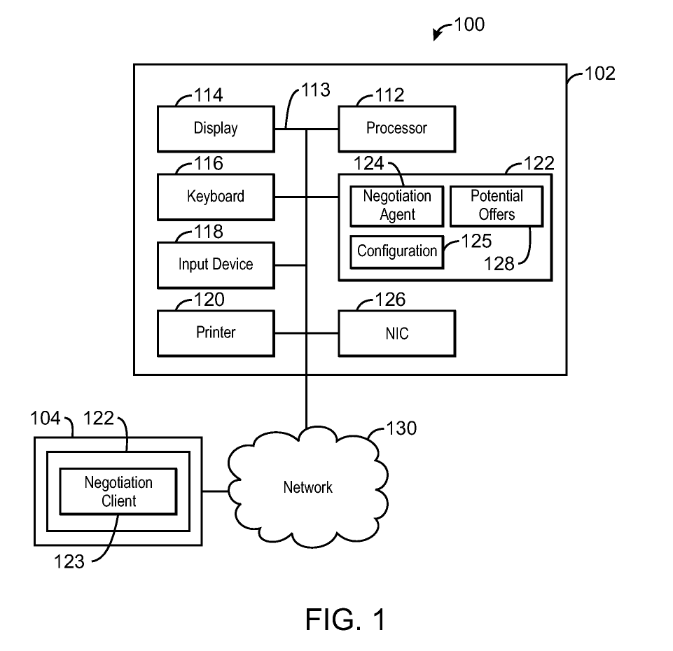

FIG. 1 is a block diagram of a system adapted to negotiate a sale according to an exemplary embodiment of the present invention. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium or a combination of both hardware and software elements.

Additionally, the functional blocks and devices of the system 100 are but one example of functional blocks and devices that may be implemented in an exemplary embodiment of the present invention. Those of ordinary skill in the art would readily be able to define specific functional blocks based on design considerations for a particular electronic device.

The system 100 may include a negotiation agent server 102, and one or more client computers 104, in communication over a network 130. In an exemplary embodiment of the invention, a user operating the client computer 104 may be a potential buyer of an item or service for sale. In such an embodiment, the negotiation agent server 102 may interact with the client computer 104 to negotiate the terms of a potential sale.

As illustrated in FIG. 1, the negotiation agent server 102 may include one or more processors 112. The processors 112 may be connected through a bus 113 to a display 114, a keyboard 116, one or more input devices 118, and an output device, such as a printer 120. The input devices 118 may include devices such as a mouse or touch screen.

The negotiation agent server 102 may have other units operatively coupled to the processor 112 through the bus 113. These units may include tangible, machine-readable storage media, such as storage devices 122.

The storage devices 122 may include media for the long-term storage of operating software and data, such as hard drives. The storage devices 122 may also include other types of tangible, machine-readable media, such as read-only memory (ROM), random access memory (RAM), and cache memory. The storage devices 122 may include the data and software used in exemplary embodiments of the present techniques.

The negotiation agent server 102 may also be connected through the bus 113 to a network interface card (NIC) 126. The NIC 126 may connect the negotiation agent server 102 to the network 130. The network 130 may be a local area network (LAN), a wide area network (WAN), or another network configuration, such as the Internet. The network 130 may include routers, switches, modems, or any other kind of interface device used for interconnection.

Through the network 130, several client computers 104 may connect to the negotiation agent server 102. The client computers 104 may be similarly structured as the negotiation agent server 102, with exception to the data and software included in the storage devices 122 of the client 102 and the server 104.

As shown, the storage devices 122 on the client computer 104 may include a negotiation client 123. In an exemplary embodiment of the invention, the potential buyer may use the negotiation client 123 conduct a negotiation for an item or service for sale. In such an embodiment, the negotiation client may display offers for sale, enable the potential buyer to accept or reject those offers, and to make counter offers.

On the negotiation agent server 102, the storage devices 122 may include the negotiation agent 124, a configuration 125, and potential offers 128. The negotiation agent 124 may be software that makes offers for sale to a potential buyer, determines whether to accept or reject counter-offers from the potential buyer.

In an exemplary embodiment of the invention, the negotiation agent 124 may operate in accordance with a configuration 125 specified by a user. Moreover, a seller of an item or service may specify the configuration 125. The configuration 125 may specify details regarding the seller's preferences about a negotiation. The specified details may include the issues to be negotiated, value options for each issue, and the relative importance of each issue to the seller.

The issues to be negotiated may be the terms of a sale. For example, in a negotiation involving laptop computers, the issues may include the unit price, quantity to be sold, and a level of support service.

The value options may be the possible values for each issue in the negotiation. For example, using the laptop scenario, the value options for unit price may be {1900, 2000, 2100, 2200, 2300, 2400, and 2500}. The value options for quantity may be {100, 200, 300, 400, and 500} units. Further, the value options for levels of support may include {“classic,” “silver,” “gold,” and “platinum”} (indicating increasing levels of quality of support).

The relative importance may reflect the seller's preferences regarding the issues to be negotiated. For example, the seller may not mind selling at a lower price, if more units can be sold. Accordingly, the seller may prioritize the number of units over the price.

The potential offers 128 may include all possible offers that the negotiation agent 124 can make during the negotiation. The potential offers 128 may be based on the issues and boundary values for the issues, specified in the configuration 125. In the laptop example, with 7 possible prices, 5 possible quantities, and 4 possible levels of service, the negotiation agent 124 may generate 7*5*4=140 possible offers.

In an exemplary embodiment of the invention, the specified details about the issues may be used to score the utility of offers sent by the negotiation agent to the potential buyer, or counter-offers received from the potential buyer. In such an embodiment, the negotiation agent 124 may use the utility score to determine whether to accept or reject a counter-offer.

The negotiation agent 124 may maintain a multi-attribute utility function for scoring all the potential offers 128. The multi-attribute utility function may score values for individual issues, and use the relative importance of each issue to determine a utility of the offer as a whole. In an exemplary embodiment of the invention, the overall utility may be determined by weighting the individual utility scores according to each issue's relative importance. The overall utility score of the offer may then be determined by summing the weighted utility scores. The utility scores for all the potential offers 128 may be normalized in a range from zero to one hundred (0-100).

The configuration 125 may also specify an initial offer, a target, and a bottom line for the negotiation. Herein, the bottom line may also be referred to as the best alternative to a negotiated agreement (BATNA). In an exemplary embodiment of the invention, the initial offer, target, and BATNA may be specified as utility scores.

The initial offer may specify the level of utility for the initial offers. The target may specify the seller's preferred utility value for a negotiated sale. The negotiation agent 124 may always accept counter-offers scored at or above the target.

The bottom line may indicate the seller's least acceptable result. The negotiation agent 124 may always reject counter-offers scored below the BATNA. As an alternative to specifying the BATNA in terms of a utility score, the BATNA may be specified in terms of bottom-line issues for the seller. For example, the seller may identify the quantity and price as bottom line issues. The negotiation agent may then calculate the BATNA using the lower bounds of the quantity and price values, and the relative importance of each.

In an exemplary embodiment of the invention, the negotiation agent 124 may employ a multiple equivalent offers strategy in the negotiation. In other words, instead of making a single offer to the potential buyer in a round of negotiation, the negotiation agent may make multiple offers of equivalent utility to the seller.

In contrast, a typical negotiation strategy may involve making equivalent offers over numerous rounds of negotiation. By making relatively equivalent offers within a single round, fewer rounds of negotiation may be needed for the potential buyer to identify favorable terms of a potential sale.

In such an exemplary embodiment, the negotiation agent 124 may make one or more offers in a single round of the negotiation. Each offer may include values for all the issues. However, the negotiation agent may bias the utility of one issue towards the potential buyer. In the laptop scenario, multiple equivalent offers may include one offer with a price that favors the buyer, another offer that favors the buyer in terms of quantity, and another offer that favors the buyer in terms of level of support.

In another exemplary embodiment of the invention, the negotiation agent 124 may employ a delayed acceptance strategy. The delayed acceptance strategy may allow the negotiation agent 124 to further explore offers even though the potential buyer's counter-offer meets or exceeds the BATNA specified by the seller. In such an implementation, if the counter-offer exceeds the BATNA, but does not meet the target, the negotiation agent 124 may delay acceptance for one or more rounds to try to reduce the gap between the counter-offer and the target.

Because the seller may not want to lose a potential sale that has met the BATNA, in such a scenario, the negotiation agent 124 may reduce the limit on the rounds of negotiation. By reducing the number of rounds, the negotiation agent 124 may reduce the likelihood that the potential buyer may quit the negotiation before an agreement is reached.

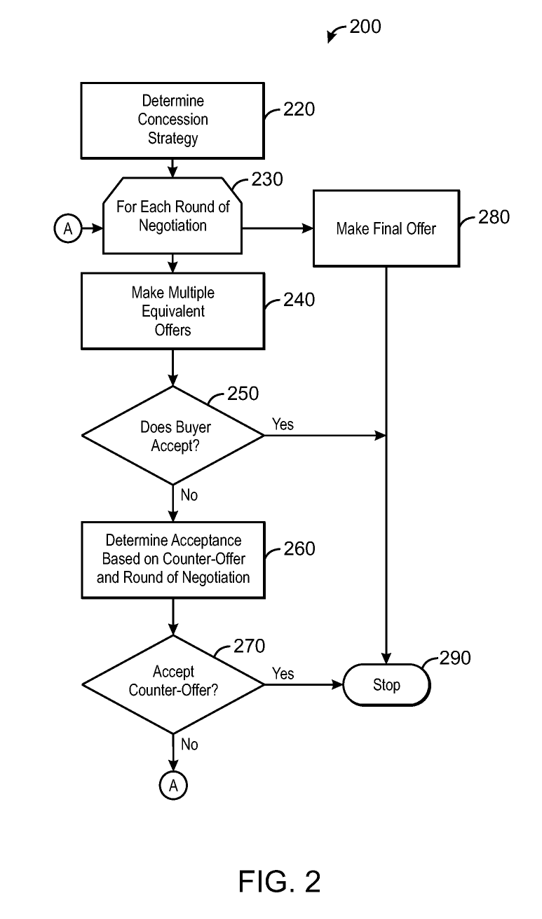

FIG. 2 is a process flow diagram of a computer-implemented method for negotiation according to an exemplary embodiment of the present invention. The method is generally referred to by the reference number 200, and may be performed by the negotiation agent 124. It should be understood that the process flow diagram for method 200 is not intended to indicate a particular order of execution.

The method begins at block 220. At block 220, the negotiation agent 124 may determine a concession strategy. The concession strategy may specify the total planned concession amount for a negotiation within the specified maximum number of rounds. The total planned concession amount may be the difference between the initial offer and the BATNA, or some lesser amount. The concession strategy may also specify the amount of concessions that the negotiation agent 124 is to make in each round.

The amount of the concession in each round may be the product of a pre-defined monotone decreasing ratio and the total planned concession amount. For example, a concession strategy of {40%, 30%, 20%, and 10%} may indicate that offers in the second round may represent a 40% decrease of the total concession amount from the offers in the first round. Offers in the third round may represent a 30% decrease in the total concession amount from offers in the second round, etc.

As shown, blocks 230-270 may be repeated for each round of the negotiation. The negotiation may run the maximum number of rounds specified in the configuration. However, the negotiation may run a fewer number of rounds based on whether and when an agreement is made with the potential buyer.

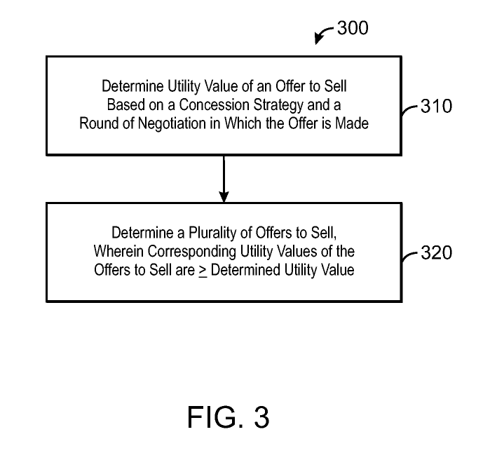

At block 240, the negotiation agent 124 may make multiple equivalent offers to the potential buyer. Making multiple equivalent offers to the potential buyer is described with reference to FIG. 3, which is a process flow diagram of a computer-implemented method for making multiple equivalent offers according to an exemplary embodiment of the present invention.

At block 310, the negotiation agent 124 may determine a utility value of the offers to be made based on the concession strategy, and the round of negotiation in which the offers are made. As stated previously, the concession strategy may specify the amount of concession in utility made from round to round. For the offers made in the first round, however, the utility value may be the initial offer specified in the configuration.

At block 320, the negotiation agent 124 may determine a plurality of offers to sell. The corresponding utility values of the offers to sell may be greater than or equal to the utility value determined at block 310.

In an exemplary embodiment of the invention, the negotiation agent 124 may select offers from the potential offers 128. For a particular utility value, the negotiation agent may select one offer for each issue. As stated previously, each offer may represent a bias towards the potential buyer for one issue.

For example, the potential offers may include 10 offers with the utility value for a particular round of negotiation. Using the laptop example, the negotiation agent 124 may select an offer with the lowest utility (to the seller) for price. Similarly, the negotiation agent may select an offer with the lowest utility for quantity, etc.

It should be noted that, in some scenarios, the potential offers 128 may not be available for all possible utility values. As such, the negotiation agent 12 may select offers that are greater than or equal to the utility value for a particular round.

Referring back to FIG. 2, at block 250, the negotiation agent 124 may determine whether the potential buyer accepts one of the multiple equivalent offers. If so, the negotiation is completed, and method 200 may end. If none of the multiple equivalent offers are accepted, the potential buyer may make a counter-offer.

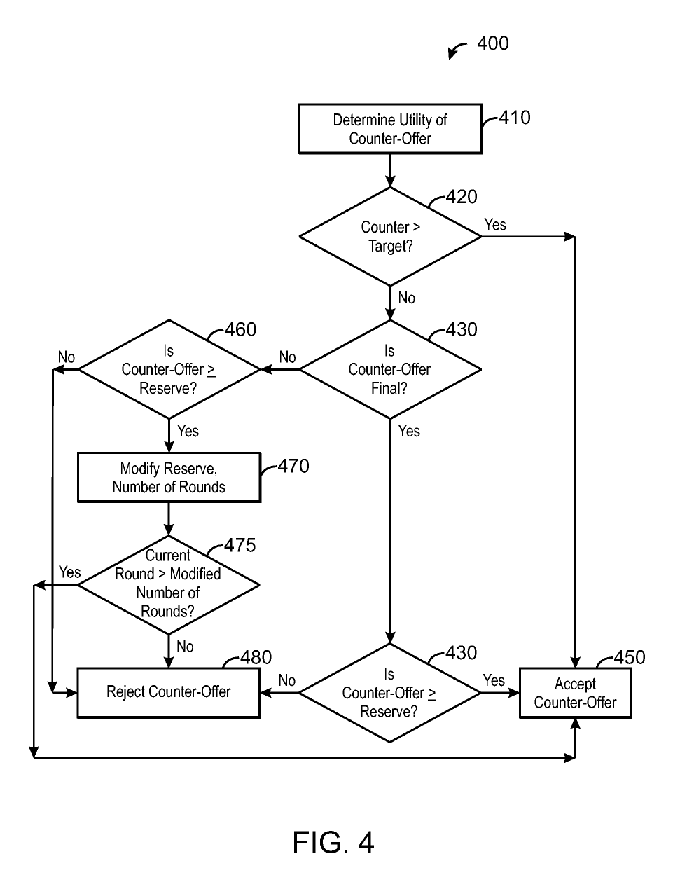

At block 260, the negotiation agent 124 may determine whether to accept based on the counter-offer and the current round of negotiation. The determination whether to accept is described in greater detail with reference to FIG. 4, which is a process flow diagram of a computer-implemented method for determining whether to accept an offer according to an exemplary embodiment of the present invention.

At block 410, the negotiation agent 124 may determine the utility of the counter-offer. As stated previously, the negotiation agent 124 may maintain a multi-attribute utility function that scores the utility of an offer or counter-offer based on the values for each issue in the offer.

At block 420, the negotiation agent 124 may determine whether the utility of the counter-offer is greater than or equal to the target specified in the configuration. If so, at block 450, the negotiation agent 124 may accept the counter-offer.

If the counter-offer is less than the target, at block 430, the negotiation agent 124 may determine whether the potential buyer specifies that the counter-offer is final. In other words, the potential buyer may indicate that no further negotiation is desired.

If the counter-offer is final, at block 440, the negotiation agent may determine whether the counter-offer is greater than a reserve utility. In the early rounds of a negotiation, the reserve utility may represent the BATNA specified in the configuration 125. However, in later rounds, the reserve utility may represent a utility between the BATNA and the target.

For example, during the negotiation, the potential buyer may make a counter-offer with a utility that exceeds the BATNA. However, if the utility does not meet or exceed the target, the reserve utility may be set to the utility of the buyer's counter-offer. As such, the reserve utility may become the new bottom-line in the negotiation, potentially resulting in a better agreement for the seller.

If the final counter-offer is greater than or equal to the reserve utility, at block 450, the negotiation agent 124 may accept. If the final counter-offer is less than the reserve utility, the negotiation agent 124 may reject the counter-offer.

If, at block 430, the negotiation agent 124 determines that the counter-offer is not final, at block 460, the negotiation agent 124 may determine whether the counter-offer is greater than or equal to the reserve. If not, at block 480, the negotiation agent 124 may reject the counter-offer.

If the counter-offer is greater than or equal to the reserve, at block 470, the negotiation agent 124 may modify the reserve utility to that of the counter-offer. Additionally, the negotiation agent 124 may modify the maximum number of rounds for the negotiation.

A prolonged negotiation may decrease the likelihood of an agreement. As such, once the potential buyer has made a counter-offer that is acceptable, the seller may desire shortening the length of the negotiation to avoid losing out on an acceptable agreement. In an exemplary embodiment of the invention, the length of the negotiation may be reduced by a number of rounds calculated according to the following equation:

R*(Uᵢ−ᵣₑₛₑᵣᵥₑ)/(Uᵢₙᵢₜᵢₐₗ−U_{BATNA}) (1)

where R is the maximum number of rounds, Uᵢ is the utility of the counter-offer, Uᵣₑₛₑᵣᵥₑ is the reserve utility, Uᵢₙᵢₜᵢₐₗ the initial offer, and U_{BATNA} is the BATNA.

At block 475, the negotiation agent 124 may check if the actual number of rounds has exceeded the calculated number of rounds. If so, the agent may accept the counter offer at 450, else the negotiation agent 124 may reject the counter offer at block 480.

Referring back to FIG. 2, at block 270, it may be determined whether the counter-offer is accepted. If so, at block 290, the method 200 may stop. If the counter-offer is not accepted, at block 230, the next round of negotiation may proceed.

If no agreement is reached, and the maximum number of rounds have been negotiated, at block 280, the negotiation agent 124 may make a final offer to the potential buyer. The final offer may include multiple equivalent offers, as with the rest of the negotiation.

The utility of the final offer may be the reserve utility. If the potential buyer has never made a counter-offer greater than the BATNA, the utility of the final offer may be equal to the BATNA. If the buyer does not accept the final offer, the negotiation concludes without an agreement.

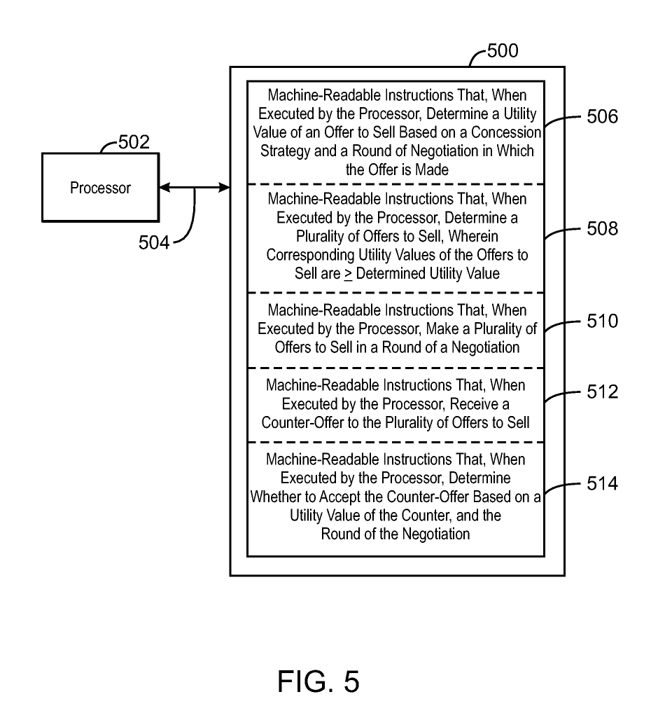

FIG. 5 is a block diagram showing a tangible, machine-readable medium that stores code adapted for negotiating a sale according to an exemplary embodiment of the present invention. The tangible, machine-readable medium is generally referred to by the reference number 500. The tangible, machine-readable medium 500 may correspond to any typical storage device that stores computer-implemented instructions, such as programming code or the like.

Moreover, tangible, machine-readable medium 500 may be included in the storage 122 shown in FIG. 1. When read and executed by a processor 502, the instructions stored on the tangible, machine-readable medium 500 are adapted to cause the processor 502 to conduct a negotiation.

A region 506 of the tangible, machine-readable medium 500 stores machine-readable instructions that, when executed by the processor 502, determine a utility value of an offer to sell based on a concession strategy and a round of negotiation in which the offer is made. A region 508 of the tangible, machine-readable medium 500 stores machine-readable instructions that, when executed by the processor 502, determine a plurality of offers to sell. The utility values of the offers to sell are greater than or equal to the determined utility value.

A region 510 of the tangible, machine-readable medium 500 stores machine-readable instructions that, when executed by the processor 502, make the plurality of offers to sell in a round of a negotiation. A region 512 of the tangible, machine-readable medium 500 stores machine-readable instructions that, when executed by the processor 502, receive a counter-offer to the plurality of offers to sell. A region 514 of the tangible, machine-readable medium 500 stores machine-readable instructions that, when executed by the processor 502, determine whether to accept the counter-offer based on a utility value of the counter-offer, and the round of the negotiation.

1. A computer system for negotiating a sale, the computer system comprising:
a processor adapted to execute stored instructions; and
a memory device that stores instructions for execution by the processor, the memory device comprising:
computer-implemented code adapted to make an offer to sell in a round of a negotiation;
computer-implemented code adapted to receive a counter-offer; and
computer-implemented code adapted to determine whether to accept the counter-offer based on a pre-determined target, a best alternative to a negotiated agreement (BATNA), and the round of the negotiation.

2. The computer system of claim 1, wherein the offer to sell comprises a plurality of equivalent offers.

3. The computer system of claim 2, wherein the offer to sell comprises a plurality of issues corresponding to the plurality of equivalent offers.

4. The computer system of claim 3, wherein each of the equivalent offers represents a bias towards a potential buyer for the corresponding issue.

5. The computer system of claim 2, wherein the computer-implemented code adapted to make the offer to sell comprises:
computer-implemented code adapted to determine a utility value to a seller of the offer based on a concession strategy and a round of negotiation in which the offer is made; and
computer-implemented code adapted to determine the plurality of equivalent offers, wherein each of a plurality of utility values corresponding to the plurality of offers is greater than or equal to the determined utility value.

6. The computer-implemented method of claim 5, wherein the concession strategy specifies an amount to reduce the utility value in one or more of a pre-determined maximum number of rounds of the negotiation.

7. The computer system of claim 1, comprising computer-implemented code adapted to reject the counter-offer if the counter-offer has a greater utility to the seller than the BATNA, the counter-value has a lesser utility value to the seller than the target, and the round of the negotiation is less than a pre-determined maximum number of rounds.

8. The computer system of claim 7, comprising computer-implemented code adapted to reduce the maximum number of rounds based on a difference between the target and the counter-offer.

9. The computer system of claim 1, wherein the pre-determined target represents, for a seller, a preferred utility value of a negotiated agreement.

10. The computer system of claim 1, wherein the BATNA represents, for a seller, a least acceptable utility value of a negotiated agreement.

11. A tangible, machine-readable medium that stores machine-readable instructions executable by a processor to execute a query, the tangible, machine-readable medium comprising:
machine-readable instructions that, when executed by the processor, determine a utility value of an offer to sell based on a concession strategy and a first round of negotiation in which the offer is made;
machine-readable instructions that, when executed by the processor, determine a first plurality of offers to sell, wherein a plurality of utility values corresponding to the first plurality of offers to sell are greater than or equal to the determined utility value;
machine-readable instructions that, when executed by the processor, make the first plurality of offers to sell in a round of a negotiation;
machine-readable instructions that, when executed by the processor, receive a counter-offer to the first plurality of offers to sell; and
machine-readable instructions that, when executed by the processor, determine whether to accept the counter-offer based on a utility value of the counter-offer, and the round of the negotiation.

12. The tangible, machine-readable medium of claim 11, comprising machine-readable instructions that, when executed by the processor, reject the counter-offer if the counter-offer has a greater utility to the seller than a best alternative to a negotiated agreement (BATNA), the counter-offer has a lesser utility value to the seller than a pre-determined target, and the round of the negotiation is less than a pre-determined maximum number of rounds.

13. The tangible, machine-readable medium of claim 12, comprising machine-readable instructions that, when executed by the processor, reduce the maximum number of rounds based on a difference between the target and the counter-offer.

14. The tangible, machine-readable medium of claim 11, comprising:
machine-readable instructions that, when executed by the processor, receive:
a plurality of specified issues for negotiation corresponding to the plurality of offers; and
a plurality of specified possible values for each of the specified issues; and
machine-readable instructions that, when executed by the processor, generate a plurality of possible offers based on the specified issues and the specified possible values.

15. The tangible, machine-readable medium of claim 14, wherein the machine-readable instructions that, when executed by the processor, select the first plurality of the offers to sell from the plurality of possible offers, based on the determined utility value.

16. The tangible, machine-readable medium of claim 14, wherein each of the plurality of offers represents a bias towards a potential buyer for the corresponding issue.

17. The tangible, machine-readable medium of claim 11, comprising machine-readable instructions that, when executed by the processor make a final plurality of offers to sell, wherein a final plurality of utility values corresponding to the final plurality of offers are each greater than or equal to a highest utility value of the counter-offer, and the final plurality of utility values are each greater than a best alternative to a negotiated agreement (BATNA)

18. A computer system for negotiating a sale, comprising:
means for making an offer to sell in a round of a negotiation;
means for receiving a counter-offer; and
means for determining whether to accept the counter-offer based on a pre-determined target, a best alternative to a negotiated agreement (BATNA), and the round of the negotiation.

19. The computer system of claim 18, wherein the offer comprises a plurality of equivalent offers.

20. The computer system of claim 18, comprising means for rejecting the counter-offer if the counter-offer has a greater utility to the seller than the BATNA, the counter-value has a lesser utility value to the seller than the target, and the round of the negotiation is less than a pre-determined maximum number of rounds.

21. A method of negotiating a sale, the method comprising:
making an offer to sell in a round of a negotiation;
receiving a counter-offer; and
determining whether to accept the counter-offer based on a pre-determined target, a best alternative to a negotiated agreement (BATNA), and the round of the negotiation.
